(19) United States
(12) Patent Application Publication
(10) Pub. No.: US 2017/0195211 A9
(43) Pub. Date: Jul. 6, 2017

(54) Efficient High-Radix Networks for Large Scale Computer Systems

(71) Applicant: Bruce Ledley Jacob, Arnold, MD (US)

(72) Inventor: Bruce Ledley Jacob, Arnold, MD (US)

(21) Appl. No.: 15/130,957

(22) Filed: Apr. 16, 2016

Related U.S. Application Data
(60) Provisional application No. 62/117,218, filed on Feb. 17, 2015.

(51) Int. Cl. H04L 12/715; H04L 12/707; H04L 12/727; H04L 12/755; H04L 12/703

(52) U.S. Cl. CPC H04L 45/04; H04L 45/021; H04L 45/28; H04L 45/121; H04L 45/22

(57) ABSTRACT

An interconnection method is disclosed for connecting multiple sub-neworks providing significant improvements in performance and reductions in cost. The method interconnects copies of a given sub-network, e.g., a 2-hop Moore graph sub-network, or a 2-hop Flattened Butterfly sub-network. Each sub-network connects to every other sub-network over multiple links, and the originating nodes in each sub-network lie at a maximum distance of 1 hop from all other nodes in that sub-network. This set of originating nodes connects to a set of similarly chosen nodes in another sub-network, for each pair of sub-networks, to produce a system-wide diameter of 4 (maximum of 4 hops between any two nodes), given 2-hop sub-networks. For example, to reach a given remote sub-network j, starting at a node in sub-network i, a packet must first reach any one of the local sub-network i's originating nodes, connected to nodes in remote sub-network j. This takes at most one hop. Another hop reaches the remote sub-network j, where it takes at most two hops to reach the desired node. The disclosed interconnection methodology scales up to billions of nodes in an efficient manner, keeping the number of required ports per router low, the number of hops to connect any given pair of nodes low, the bisection bandwidths high, and it provides easily determined routing. Moreover, because each sub-network can be identical, only one PCB design for the subnet needs to be designed, tested, and manufactured. All of these design features significantly reduce costs and while also significantly increasing performance.

### CROSS-REFERENCES TO RELATED APPLICATIONS

This non-provisional United States (U.S.) patent application claims the benefit of U.S. Provisional Patent Application No. 62/117,218, filed Feb. 17, 2015, and by petition to restore the date to file and claim its benefit is extended to Apr. 17, 2016.

### FIELD OF THE INVENTION

The invention pertains generally to multiprocessor interconnection networks, and more particularly to multiprocessor networks using Moore graphs and other high-radix graphs as sub-networks and a network interconnection topology to connect the sub-networks.

### BACKGROUND

Interconnection network topologies used in multiprocessor computer systems transfer data from one core to another, from one processor to another, or from one group of cores or processors to another group, within the inter-connected nodes of the multiprocessor computer system. This interconnection network topology precisely defines how all the processing nodes of the multiprocessor system are connected. The number of interconnection links in a multiprocessor computer system can be very large, inter-connecting thousands or even millions of processors, and system performance can vary significantly based on the efficiency of the interconnection network topology.

Thus, the interconnection network topology is a critical component of both the cost and the performance of the overall multiprocessor system. A key design driver of these multiprocessor networks is achieving the shortest possible latency between nodes. I.e., both the number of intermediate nodes between a sending and receiving node (the so-called number of “hops” between those nodes), and the speed or type of network technology connecting the nodes, all play a significant factor in the performance of the network interconnection topology.

Other design features impacting both system cost and performance are the number of pins on each node integrated circuit (IC), the number of ports or connections of each node (how many connections each node has with the rest of the multiprocessor system), the internode signal latency, the bandwidth of the internode interconnections, and the power consumed by the system. Traditionally, system bandwidth and system power consumption have been roughly proportional.

Many prior art interconnection networks were designed using topologies such as dragonflies, butterflies, hypercubes, or fat trees that required large-scale network super routers. However, as a result of the rapid evolution of the underlying technologies, multiprocessor network topology designs have also changed, presenting multiprocessor designers with new possibilities to drive down the cost of the multiprocessor system, while keeping or raising its performance.

Disclosed and claimed herein is a new multiprocessor network organization that interconnects high-radix, low-latency sub-networks such as Moore graphs, Flattened Butterfly networks, or similar multiprocessor network interconnection topologies.

### SUMMARY

The present invention provides apparatus and methods for connecting multiple sub-networks into a multiprocessor interconnection network method and apparatus capable of scaling up to billions of interconnected nodes. This system-wide interconnection of the sub-networks, scalable up to billions of nodes, does so in an efficient manner, keeping the number of required ports per router low, the number of hops to connect any given pair of nodes low, the bisection bandwidths high, provides easily determined routing, and each sub-network can be identical, resulting in one PCB design for the sub-networks, and all of these design features significantly reduce costs and while significantly increasing sub-network and system-wide performance.

In one embodiment, the sub-networks of the multiprocessing network are all scalable Moore graph networks having substantially the same topology so that one sub-network circuit-board design can be used for all the sub-networks.

Another embodiment has a hierarchical routing table at each node with a routing table initialization algorithm at each node which initializes the hierarchical routing table at each node, identifying the port number for each node in the local sub-network, and the hierarchical routing table identifying a node in the local sub-network for each remote sub-network. In a refinement, each node has a network routing algorithm and it maintains and updates the hierarchical routing table with the shortest possible latency between the interconnected nodes of the multiprocessor network.

In yet a further refinement, an embodiment puts a failed node recovery routine at each node which marks the node-ID of unresponsive nodes in a Moore graph routing table, and then broadcasting the node-ID of the unresponsive node to all other nodes in the multiprocessor network, and those other nodes then run the routing table initialization algorithm again, updating the hierarchical routing table to route around the failed node. In further embodiments, each scalable Moore network is on a printed circuit board (PCB), providing the same PCB design for each PCB in the network.

In yet another embodiment, the multiprocessing network has n number of input and output (I/O) ports per node, each node connects to an immediate neighborhood of a n-node subset of nodes, and within this neighborhood of nodes each node communicates with one hop to every other node in the neighborhood of nodes, and communicates with all other nodes in the Moore graph sub-network with two hops.

Another embodiment connects each node on the PCB in a Petersen graph network topology. Still another embodiment has a scalable, multi-rack level network of interconnected nodes, interconnected PCBs, and interconnected racks, in a multi-layered network of Moore graph sub-networks, and, as noted, the PCB have substantially similar designs, with a maximum intra-network latency between processor nodes on the PCB of two hops, and a four hop latency between the scalable, multi-rack level network of interconnected PCBs, interconnected racks, with multiple routing tables for the multi-node, multi-PCB, and multi-rack area networks.

Yet another embodiment has each node in the scalable multi-rack area network connected to a different PCB, in a different rack, in the multi-layered network of Moore graph sub-networks. Still another embodiment connects the nodes of each sub-network with a Petersen graph network, and a Hoffman-Singleton graph interconnects all the Petersen graph sub-networks.

In a further refinement, the multiprocessing network has a hierarchy of table-initialization algorithms for each node, PCB, rack, and the multi-rack Moore graph networks in the multi-layered network of Moore graph sub-networks, and each level of the multi-layered network of Moore graph sub-networks has a failed node recovery algorithm which updates the routing table when any nodes fails, the PCB, the rack, and the multi-rack routing tables, depending on which component, at which level in the multi-rack Moore graph networks fails.

In another embodiment of the invention, a large-scale multiprocessor computer system contains multiple PCB boards with identical layouts, the multiple processing nodes on each PCB board are interconnected in a Moore graph network topology, and each PCB fits into a server-rack, creating a multiple PCB server-rack network.

Among the many possibilities contemplated, another embodiment has the large-scale multiprocessor interconnected in a Fishnet rack-area network, interconnecting multiple PCBs. According to one form of the invention the multiprocessor computer system constructs a routing table having one entry for each node in each sub-network.

Another embodiment contains a microprocessor and memory at each processing node, the microprocessor has direct access to the memory of the node, and each microprocessor has its memory mapped into a virtual memory address space of the entire large-scale multiprocessor computer network of interconnected processing nodes.

In a method embodiment of recovering from a node failure in a multiprocessor computer system configured in a multi-layered network of Moore sub-networks, all the sub-networks are interconnected in a Moore graph network topology, each node has a router, a routing algorithm, a routing table, and the steps of the method are, 1) marking a node-ID as a failed node when a sending-node fails to receive an expected response from a receiving node, 2) the sending-node broadcasts the node-ID of the failed node to its sub-network, 3) all nodes in the sub-network update their routing table and using random routing until the table-initialization algorithm at each node resets its routing table.

Another embodiment uses a Fishnet multiprocessor interconnect topology to interconnect multiple copies of similar sub-networks, giving each sub-network having a 2-hop latency between the n nodes of the sub-network, and a system-wide diameter of 4 hops. Yet another refinement of the Fishnet interconnect has all sub-networks of 2-hop Moore graphs. Still another refinement of the Fishnet interconnect provides an embodiment of Flattened Butterfly sub-networks. Another embodiment of the Fishnet interconnect is having them interconnect Flattened Butterfly sub-networks of N×N nodes, the Fishnet network interconnect having 2N⁴ nodes, 4N−2 ports per node, and a maximum latency of 4 hops.

Another embodiment extends the 3D torus to higher dimensions, in which the length of each “side” of the n-dimensional rectangle is similar to all others, and the nodes along a linear path in a given dimension are connected in a ring topology.

Another embodiment extends the 2D Flattened Butterfly to higher dimensions, in which the length of each “side” of the n-dimensional rectangle is similar to all others, and the nodes along a linear path in a given dimension are connected in a fully connected graph topology.

Other embodiments use a high-radix graph as the interconnection network topology, providing lower per-link bandwidth with a total, overall bandwidth performance similar to or higher than current high performance multiprocessor interconnection network topologies.

According to one form of the invention an Angelfish network interconnects sub-networks of the same type, each sub-network using p ports per node, each sub-network has n nodes, a diameter of 2 hops, each pair of sub-networks interconnects with p links creating redundant links between each pair of sub-networks, and the diameter of the Angelfish network is 4 hops.

In another embodiment of the Angelfish network embodiments, the Angelfish network interconnects sub-networks connected in a Petersen graph network topology. In another embodiment of the invention, the Angelfish network interconnects sub-networks are interconnected in a Hoffman-Singleton graph network topology.

Another embodiment is a multidimensional Angelfish Mesh interconnecting multiple sub-networks having n-nodes and a latency of two hops, each sub-network has m ports per router, and the multidimensional Angelfish mesh interconnect topology has n(n+1)² nodes, 3m ports per router, and a maximum latency throughout the multidimensional Angelfish mesh interconnect of 6 hops.

In yet another embodiment the Angelfish Mesh network interconnects Petersen graph sub-networks. And still another embodiment the Angelfish Mesh interconnects Hoffman-Singleton graph sub-networks.

In a further embodiments, the each node of the multiprocessing network has multiple ports, the ports connecting their nodes to the ports of other processing nodes, the interconnected nodes connect in a scalable network topology, the network divided into sub-networks, each sub-network having substantially the same sub-network topology, each sub-network circuit-board design substantially the same for all sub-networks; and a Moore graph network topology connecting the nodes in each sub-network.

In another embodiments, the nodes of the multiprocessing network have n number of I/O ports per node, m number of nodes within sub-networks, each node connects to an immediate neighborhood of a n-node subset of nodes within the sub-networks, each node having one hop to communicate within the n-node immediate neighborhood of nodes, and the m nodes of the sub-network of that node communicates in two hops to communicate with the sub-networks.

In another embodiment of the invention, the multiprocessing network contains n additional number of I/O ports per node, each port connects to the port of a node in a remote sub-network, the multiprocessing network has m(m+1) nodes, and a diameter of 4 hops. In another embodiment of the invention, the multiprocessing network has 1 additional input and output I/O ports per node, the additional port connected to the port of a node in a remote sub-network; the entire network has m(m+1) nodes; and the entire network having a diameter of 5 hops.

In a further embodiments, the multiprocessing network additionally has 2n more I/O ports per node, each port connects to the port of a node in a remote sub-network, and the multiprocessing network has m(m+1)² nodes, and a diameter of 6 hops. In another embodiment of the invention, the multiprocessing network has 2 additional I/O ports per node, each port connects to the port of a node in a remote sub-network, and the multiprocessing network has m(m+1)² nodes, and a diameter of 8 hops.

Various other objects, features, aspects, and advantages of the present invention will become more apparent from the following detailed description of embodiments of the invention, along with the accompanying drawings. However, the drawings are illustrative only and numerous other embodiments are described below. Additionally, the scope of the invention, illustrated and described herein, is only limited by the scope of the appended claims.

### BRIEF DESCRIPTION OF THE DRAWINGS

FIG. 1 is a multiprocessor board area and rack area network.

FIG. 2 is a Petersen Network embodiment of the board area network of FIG. 1.

FIG. 3 is one embodiment of a Hoffman-Singleton of the rack area network of FIG. 1.

FIG. 4 is another view of the Hoffman-Singleton Network of FIG. 3.

FIG. 5 is yet another view of the Hoffman-Singleton Network of FIG. 3.

FIG. 6 is another embodiment of the Hoffman-Singleton Network of FIG. 3.

FIG. 7 is a rack area inter-network of FIG. 1 with a single wire per pair of boards.

FIG. 8 is a two-hop subset of the Petersen Network of FIG. 2.

FIG. 9 is a two-hop subset of the Hoffman-Singleton Network of FIG. 2.

FIG. 10 is a rack area inter-network of FIG. 1 with multiple wires per pair of boards.

FIG. 11 illustrates a link failure in the Petersen Network of FIG. 2.

FIG. 12 illustrates a link failure in the Hoffman-Singleton Network of FIG. 6.

FIG. 13 illustrates a Flattened Butterfly network.

FIG. 14 illustrates an embodiment of multiple interconnected Flattened Butterfly sub-networks, with a single wire per pair of Flattened Butterfly sub-networks.

FIG. 15 illustrates an embodiment of multiple interconnected Flattened Butterfly sub-networks, with multiple wires per pair of Flattened Butterfly sub-networks.

FIG. 16 disclosed an embodiment of a 3D Flattened Butterfly network.

FIG. 17 illustrates two Angelfish networks, the full Angelfish network and the Angelfish Lite embodiments.

FIGS. 18A and 18B disclose the top and bottom views, respectively, of an embodiment of an Angelfish Mesh interconnecting the Peterson graphs disclosed in FIG. 2.

FIG. 19 discloses another embodiment, a sequence of torus organizations.

FIG. 20 discloses another embodiment of the Fishnet configuration interconnecting sub-networks.

### DETAILED DESCRIPTION

The embodiments disclosed herein describe and claim different embodiments of multiprocessor computer networks using high-radix graphs like Moore graphs (i.e., graphs that approach the Moore limit) as the processor-to-processor (or processor-to-memory, or memory-to-memory) and inter-networks interconnection topology.

The high-radix multiprocessor networks disclosed herein are constructed with a multi-hop network that yields the largest number of nodes reachable with a maximum or expected hop count, and a fixed number of input and output (I/O) ports on each node. The resulting networks are scalable, such that they are suitable for implementing a network-on-chip for multiple cores on a CPU, a board-area network on a single large PCB within the server rack, a rack-area network of multiple PCBs in a server rack, and multiple racks in a full-scale enterprise network.

For the purposes of this disclosure the terms rack and cabinet are used interchangeably. Thus, a rack is a metal frame manufactured to hold various computer hardware devices such as an individual integrated circuit (IC) boards and the rack fitted with doors and side panels (i.e., the rack is a cabinet).

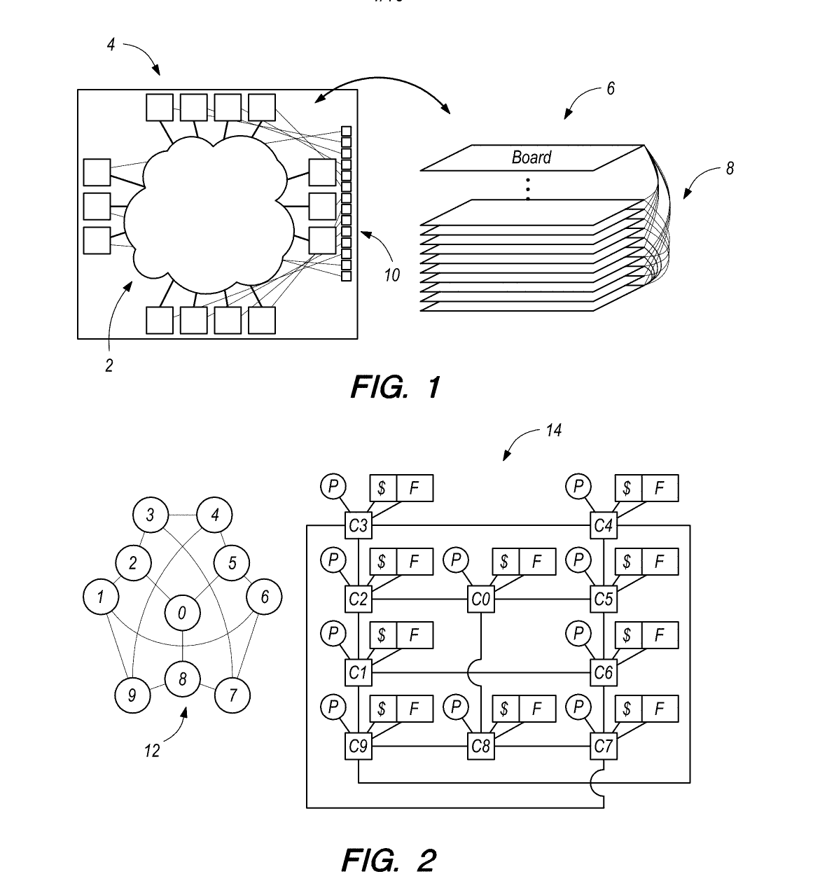

FIG. 1 shows two aspects of a cabinet-scale system: a board-area network 2 on a circuit board 4 and then multiple boards 6 connected by a rack-area network 8. Additionally, in high performance data centers many rack-area networks would be networked for processing intensive applications like warehouse scale computer centers used in cloud computing.

A Moore graph embodiment provides a natural hierarchy from individual processors to the interconnection of multi-racks: a board-area network 2 connects all the processing nodes on each multiprocessor board 4, through off-board I/O ports 10, connecting all the boards within a rack 6 in a rack-area network 8, and then connecting multiple racks in large inter-rack networks, with hundreds or thousands of interconnected processing nodes.

Moore graph embodiments, provide a scalable processor interconnect topology to interconnect as many nodes as possible, with the shortest possible latency between any two sending and receiving nodes. Using Moore graphs to inter-construct any of the multiprocessor board, rack, or inter-rack networks yields the largest number of nodes reachable with a desired maximum hop count (with the shortest latency) and a fixed number of I/O ports on each node, resulting, in one embodiment, with a PCB-area network that is the same (or substantially the same) for all PCBs within the server rack.

FIG. 2 discloses a PCB embodiment of a Moore graph embodiment. The board-area network of FIG. 2 uses a 10-node Petersen graph 12 with the maximum number of nodes reachable with three I/O ports per node and a two-hop worst-case latency. Each processing node in the Petersen graph 12 of FIG. 2 has three network ports, and overall any two sending and receiving nodes require a maximum of two hops to communicate, i.e., no more than two “hops” are required for one node to reach any other node (i.e., 10 nodes, 3 links per node, and all nodes reachable in 2 hops). This is equivalent to the network or graph “diameter.”

Thus, Moore graph embodiments are easily implemented in an inter-node PCB network, limited only by the space on the board and the expense of the PCB. The FIG. 2 Petersen graph embodiment requires no special routing, and its interconnect paths can be built on a simple two-layer PCB. The Petersen graph embodiment on the right side of FIG. 2 has ten nodes 14, and each network interface controller chip is shown with three network ports, a CPU port, and memory ports for DRAM cache and flash storage. Unless otherwise stated explicitly, the boundaries shown in all of the figures are virtual and represent different circuit functions, each of which could be integrated in the same board or the same package or the same chip, just as easily as being separate physical devices. So, for example, the nodes in FIG. 2 that are shown as a combination of separate chips, could each be implemented as single chips integrating processor, network interface, and memory controller, all connected across a PCB, or the entire diagram could all be integrated onto a single die. The invention is not limited by differences in packaging.

The next level of the hierarchy is the rack-area network, which connects all the board-area networks shown in FIG. 1 in one rack. All the board networks are interconnected, using either a Moore graph topology or another high-radix inter-network embodiment, thereby creating a rack-level network. In the case of a Moore topology, the number of off-board (off-PCB) connections would be O(n²) per board, or O(n³), or more wires per rack, depending on the Moore graph chosen for the rack-level network. To accommodate the rack-level network interconnect, an embodiment could change the board layout to fit a particular Moore graph rack-area network topology.

While a Petersen graph is acceptable for a small number of nodes per board, and a small number of boards per rack, more complex graphs may be necessary when dealing with large number of nodes. Large-scale systems challenge multiprocessor-network designers to keep the latencies small (only a few hops between any two nodes) and to provide easily manufactured designs, i.e., by minimizing the number of different board layouts.

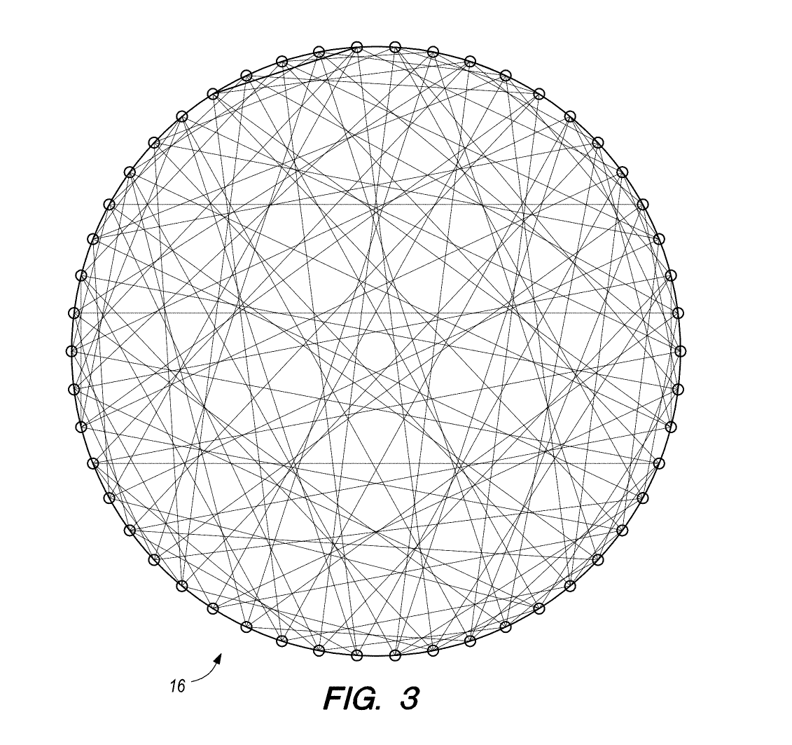

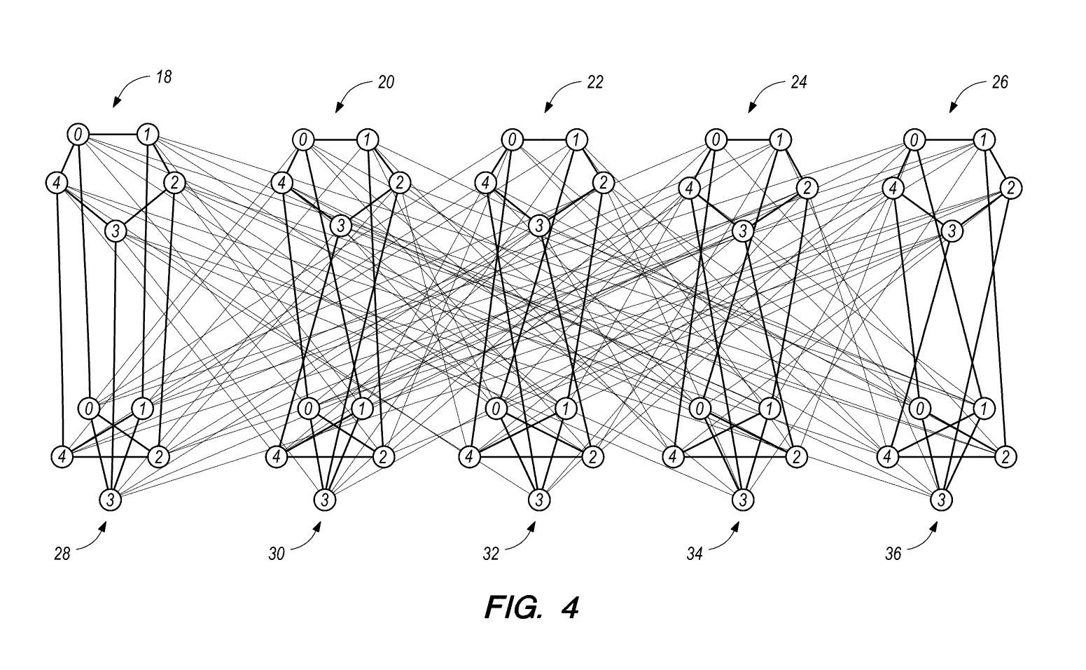

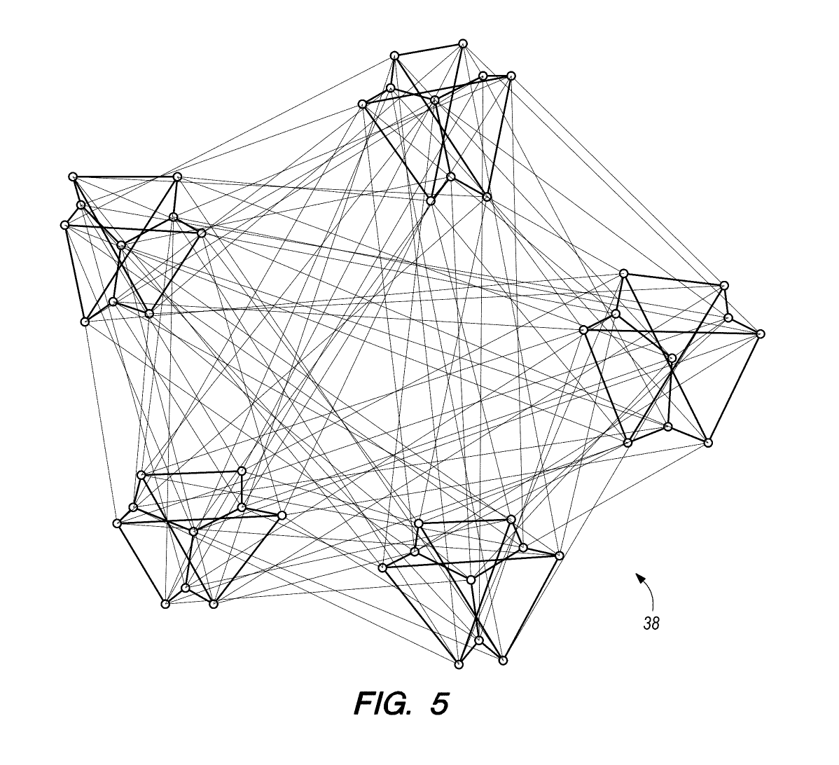

In one embodiment, two example Moore graphs implement a hierarchical inter-network system: a 10-node Petersen graph, and a 50-node Hoffman-Singleton graph 16 (which is shown in FIG. 3), where each sub-network is a Petersen graph, and the inter-network is formed by the links that combine the separate Petersen graphs into a Hoffman-Singleton graph. As can be seen in FIGS. 4 and 5, which are rearrangements of the Hoffman-Singleton graph shown in FIG. 3, the Hoffman-Singleton graph contains separate copies of the Petersen graph as sub-graphs. This embodiment creates a larger-scale system, spanning multiple boards, and each board has an identical layout. The embodiment also provides a board-to-board wiring topology implementing the larger-scale network. Moore graphs provide the board-level network and the system-level inter-network.

Overall, the disclosed embodiments easily cover large-scale systems with thousands or millions of nodes, with manufactured and tested boards, and all nodes, boards, and racks interconnected with a Moore graph, or other high-radix networks.

Multi-Board Moore Graph Networks Using Identical Board Layouts

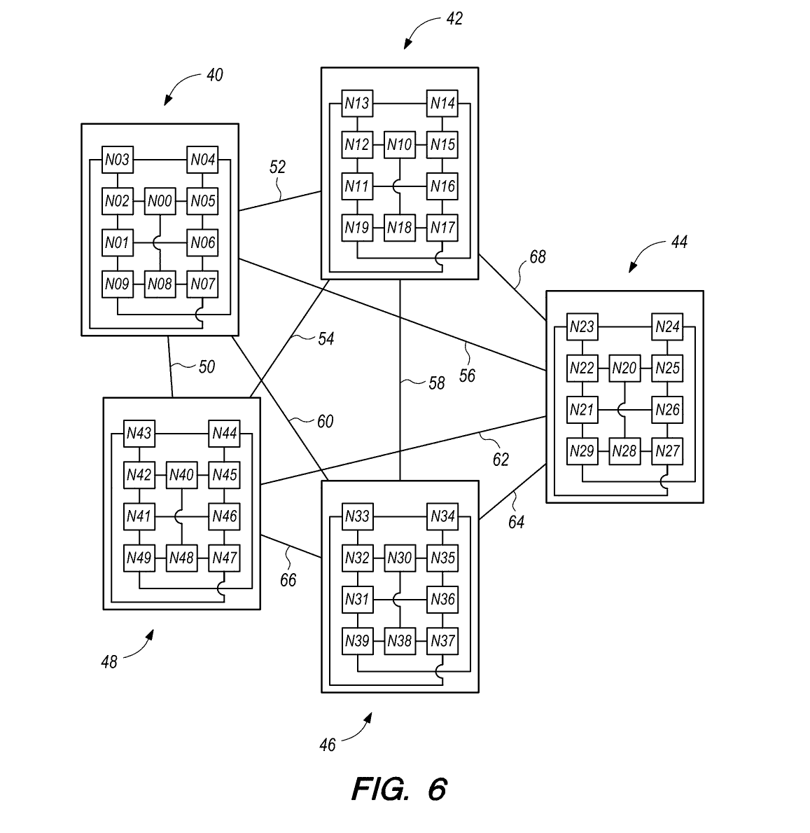

FIG. 6 shows one such large-scale system embodiment. It implements a 50-node Hoffman-Singleton graph 16 connecting five copies of the 10-node Petersen graph. Thus, FIG. 6 shows a multiprocessor having five interconnected boards, each board a sub-network having 10 nodes. The Hoffman-Singleton graph embodiment in FIG. 6 has a network of 50 nodes, each node having seven I/O ports, and all nodes are reached with a maximum of two hops.

As noted, the Hoffman-Singleton graph 16 embodiment interconnects five Petersen graphs. The basic Petersen graph is shown in FIG. 2, in both graph form and in example board-layout form, and the reorganized Hoffman-Singleton graph into five identical Petersen graphs is shown in FIGS. 4 and 5.

One could construct the Hoffman-Singleton graph in FIG. 4 as follows: (1) take the five pentagons 18, 20, 22, 24, 26 and the five pentagrams 28, 30, 32, 34, 36 (i.e., the star shaped graphs along the bottom of FIG. 4); (2) label the vertices of each pentagon and the vertex of each pentagram, (3) arrange each vertex so the vertices of each pentagon 18, 20, 22, 24, 26 are adjacent to vertices of each pentagram 28, 30, 32, 34, 36; and (4) join the vertices of the five pentagons 18, 20, 22, 24, 26 and five pentagrams 28, 30, 32, 34, 36 (all indices are mod 5).

Additionally, in FIG. 4 the edges connecting each pentagon to each pentagram make an embedded Petersen graph. These Petersen graphs in FIG. 4 are in darker lines in than the other graph edges, highlighting the fact that the 50-node Hoffman-Singleton graph can be divided into five interconnected Petersen graphs. FIG. 5 is another view of the same Hoffman-Singleton graph of embedded Petersen graphs shown 38 in FIG. 4, i.e., FIG. 5 simply reorganizes the graph in FIG. 4. Also, one can clearly see the Petersen subgraphs in FIG. 5 are the same Petersen graph in FIG. 2.

Thus, FIGS. 4 and 5 show an inter-network of five sub-networks, with each sub-network comprising the 10-node Petersen graph of FIG. 2, and, if each sub-network is a separate board (as shown in FIG. 6), then each board can be identical in layout. This means that only one board design needs to be created, tested, and manufactured, and the resulting system will be comprised of multiple copies of that one board design.

FIG. 6 shows the resulting system. Each board-area network 40, 42, 44, 46, 48 is a separate Petersen graph using an identical board layout. Each node on each board has seven ports, three of which are used to connect to the nodes on the same board. The other four ports are used to connect to off-board nodes.

FIG. 6 also shows the inter-board wires leaving each board 50, 52, 54, 56, 58, 60, 62, 64, 66, 68 (each of these lines is ten wires) in the network topology described above, which scales linearly with the total number of nodes in the network, i.e., each board-area network 40, 42, 44, 46, 48 has forty (40) wires exiting it. This might be problematic for large numbers of boards, if, for example, each board needed to have thousands or tens of thousands of wires (or more) exiting it. In such a case, a network designer could reduce the number of inter-board wires, but at a cost in performance.

Reducing Inter-Board Wire Count to One Connecting Each Pair of Boards

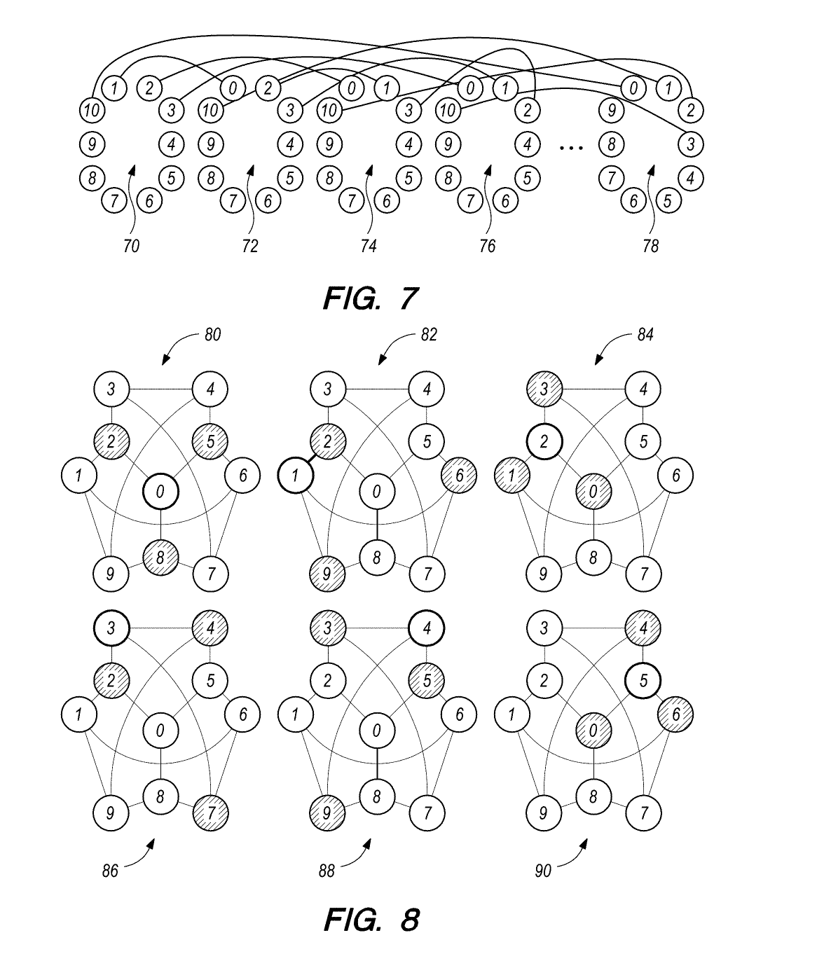

FIG. 7 shows a rack-area network, using the Petersen graph embodiment, but with only ten wires leaving each board, as opposed to the forty wires leaving each Petersen graph in the embodiment described above. The total number of boards in this embodiment is eleven, more than twice the size of the rack-area network in FIG. 5. The cost is the maximum latency: the network topology in FIG. 7 uses a single wire to connect each pair of boards, and its worst-case number of hops is five. In general, for a given n-node board area network of h maximum hops, and one additional network port on each controller, this embodiment connects n+1 boards in a complete graph, creating a 2h+1 hop network of n+1 boards of n nodes each, yielding a network of n²+n nodes.

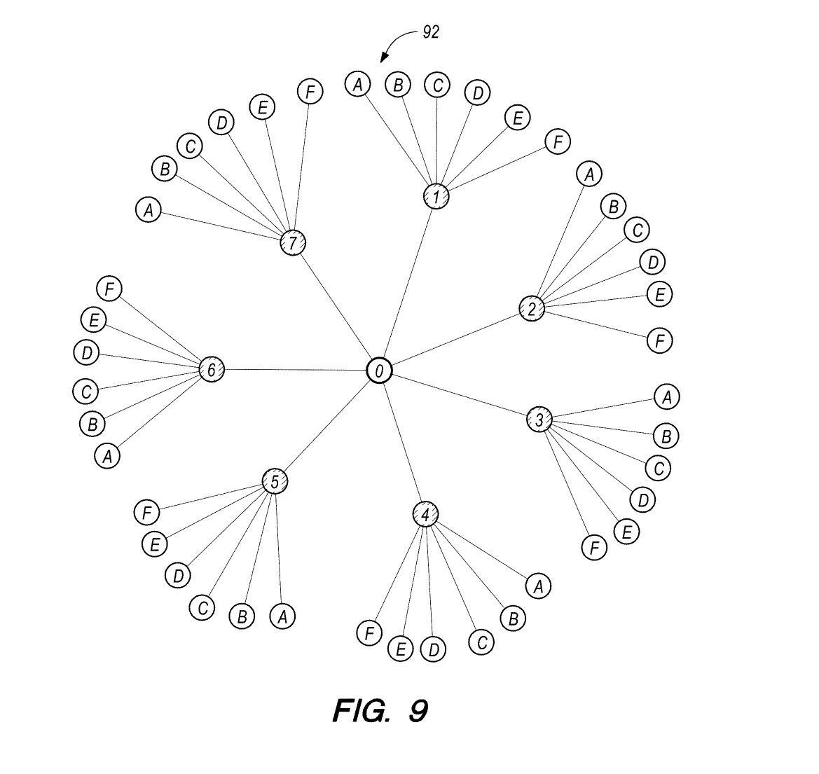

This is the Fishnet interconnect, a way to connect multiple copies of a given sub-network, for instance a 2-hop Moore graph or 2-hop Flattened Butterfly network. Each sub-network is connected by one or multiple links, the originating nodes in each sub-network chosen so as to lie at a maximum distance of 1 from all other nodes in the sub-network. For instance, in a Moore graph, each node defines such a subset: its nearest neighbors by definition lie at a distance of 1 from all other nodes in the graph, and they lie at a distance of 2 from each other. FIGS. 8 and 9 illustrate. A Flattened Butterfly defines numerous such nearest-neighbor subsets, as described later.

Using nearest-neighbor subsets to connect the members of different sub-networks to each other produces a system-wide diameter of 4, given diameter-2 sub-networks: to reach remote sub-network i, one must first reach one of the nearest neighbors of node i within the local sub-network. By construction, this takes at most one hop. Another hop reaches the remote sub-network, where it takes up to two hops to reach the desired node. The “Fishnet Lite” variant uses a single link to connect each sub-network and has maximum 5 hops between any two nodes, as opposed to 4.

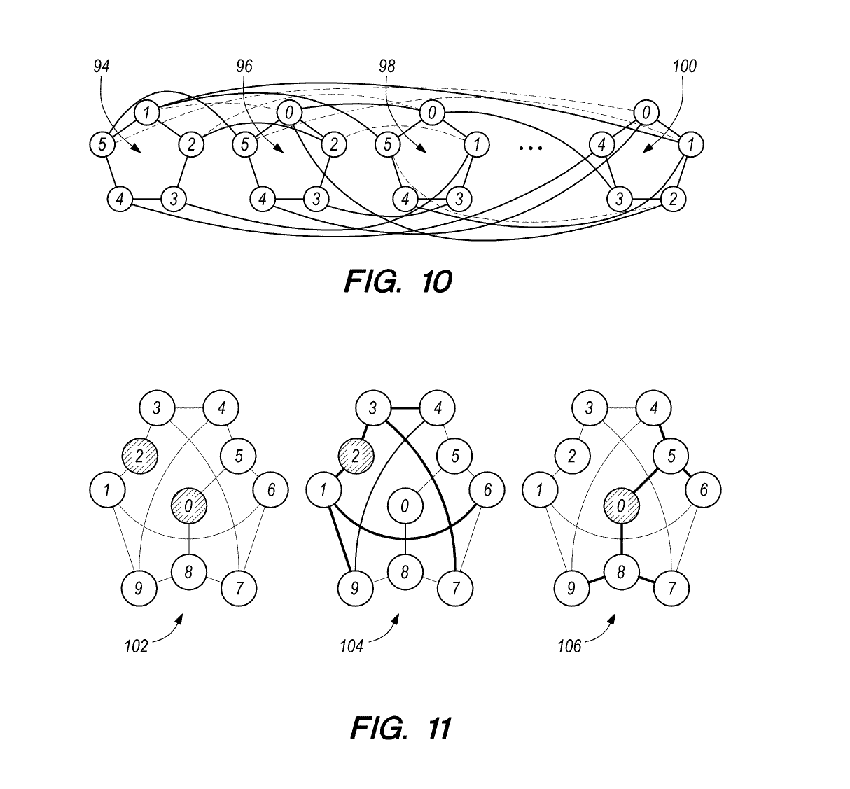

The fundamental idea is illustrated in FIG. 10 is as follows: given a 2-hop sub-network of n nodes, each node having p ports (in this case each sub-network has 5 nodes, and each node has 2 ports), one can construct a system of n+1 sub-network, in two ways: the first (the “Lite” version) uses p+1 ports per node and has a maximum latency of five hops within the system; the second uses 2p ports per node and has a maximum latency of four hops. The nodes of sub-network 0 are labeled 1 . . . n; the nodes of sub-network 1 are labeled 1, 2 . . . n; the nodes of sub-network 2 are labeled 0, 1, 3 . . . n; the nodes of sub-network 3 are labeled 0 . . . 2, 4 . . . n; etc. In the illustration, node i in sub-network j connects directly to node j in sub-network I, through the dotted lines. Through the solid lines, the immediate neighbors of node i in sub-network j connect to the immediate neighbors of node j in sub-network i.

Thus, FIG. 7 discloses a method to construct an inter-network of sub-networks that is extremely pin-efficient. This is a scalable construct that produces, for any n-node board-level network, a rack-area network of n²+n nodes, with each node in the board-area network defining a connection to a different external board-area network. The cost is but a single extra port per router. For instance, a board network based on a Petersen graph, with ten nodes per board and three ports per router, yields a 110-node rack-area network comprised of eleven boards and four ports per router. In this embodiment, the nodes in Board 0 70 are labeled 1 to 10; the nodes in Board 1 72 are labeled 1 to 10, and board 2 74 and board 3 76, etcetera on up to the nodes in Board 10 78. For all boards and nodes, the controller at Board X, Node Y connects to the controller at Board Y, Node X. For example, FIG. 7 shows the following connections between boards:
Board 0 70, Node 1 connects to Board 1 72, Node 0.
Board 0 70, Node 2 connects to Board 2 74, Node 0.
Board 0 70, Node 3 connects to Board 3 76, Node 0.
. . .
Board 0 70, Node 10 connects to Board 10 78, Node 0.
Board 1 72, Node 2 connects to Board 2 74, Node 1.
Board 1 72, Node 3 connects to Board 3 76, Node 1.
. . .
Board 1 72, Node 10 connects to Board 10 78, Node 1.
Board 2 74, Node 3 connects to Board 3 76, Node 2.
. . .
Board 2 74, Node 10 connects to Board 10 78, Node 2.
Board 3 76, Node 10 connects to Board 10 78, Node 3.
. . . and so forth until Board 9 (not shown), Node 10 connects to Board 10, Node 9

Thus, the network can be constructed with exactly n off-board network connections for each board, and each board can have identical layout. For a board-area network of two hops and three network ports per router, this yields a rack-area network of (2+1+2) 5 hops, with each router requiring four network ports.

In another embodiment, using a Hoffman-Singleton graph for the board-area network, using seven controller ports to connect 50 nodes in a two-hop board-area network, each node would need an additional eighth port to connect to a single off-board node. This embodiment provides a rack-area network of 51 boards, giving 51 boards at 50 nodes per board, and for a total of 2550 nodes in the rack-area network.

The process scales to very large sizes: in a much larger embodiment, a Moore sub-network can be constructed of 1058 interconnected nodes, using 35 ports on each node to connect all 1058 nodes in a two-hop network. 1059 of these sub-networks can be connected, using one additional port per node, such that a total of 1,120,422 nodes are connected in a five-hop network, with 36 ports per node.

The primary weakness of this topology is a lack of redundant connections between different boards: the single connection between each pair of boards represents a single point of failure, so if this link goes down, any re-routing must necessarily traverse through a third board, which could present traffic problems. Thus, we call this a Fishnet “Lite” interconnect. The next embodiment is the regular Fishnet interconnect, which solves this problem, increasing the network reliability, as well as reducing the worst-case latency.

Highly Redundant Inter-Network with Reduced Maximum Latency

This embodiment of the inter-network construction technique creates a redundant network based on the basic embodiments disclosed above, provides a high degree of reliability, and decreases the maximum number of hops across the network by one.

FIGS. 8 and 9, disclose board-level networks based on two-hop Moore graphs. Each node in these board-level networks connects to an immediate neighborhood of n nodes, where n is the number of I/O ports per node; each node thus, by its set of nearest neighbors, defines an n-node subset of nodes that are two hops from each other and that are one hop away from all other nodes in the graph. FIG. 8 discloses this embodiment using a Petersen graph, and FIG. 9 illustrates this in a Hoffman-Singleton graph 92 (for clarity, only relevant lines of the Hoffman-Singleton graph are shown).

FIG. 8 shows the two-hop subsets of the Petersen graph, the set of shaded nodes in each of the six figures, 80, 82, 84, 86, 88, 90—the nodes in the 3-node subset requiring 2 hops to reach nodes in the 3-node subset, and a single hop to reach all other nodes in the Petersen graphs.

The graphs in FIGS. 8 and 9 represent the largest number of nodes one can reach from a starting point, given a fixed number of I/O ports and a maximum hop count. In these graphs, each node defines a two-hop subset that lies at a distance of one (1) from all other nodes and which can be used to provide redundant links between boards (between sub-networks).

As disclosed in FIG. 2, and instead of using the numbered node to connect each board/sub-network pair, we use the numbered node to identify a unique two-hop subset that will connect to the identified remote sub-network. Because each of these two-hop subsets are at exactly a distance of two hops from each other, and at a distance of one less than the maximum hop distance from all other nodes, this effectively reduces the cross-network latency by one.

Compared to the “Lite” version, instead of one additional port, the number of ports is doubled (each nearest neighbor of sub-network i, node j connects to a nearest neighbor of sub-network j, node i—each node has p ports and therefore p nearest neighbors; thus, the total number of connections between sub-networks is p and not 1 as it is in a “Lite” variant). Because the set of p nearest neighbors lies, by definition, at a maximum distance of 1 from every other node in the sub-network (it only takes 1 hop to reach a node in the nearest-neighbor subset), the number of hops is reduced by one; thus, the diameter of a regular Fishnet network is 4, not 5.

In the two-hop network embodiments, the maximum distance within the sub-network is two, by definition. A maximum two-hop subset is defined for each remote sub-network. For each maximum two-hop subset, the distance from any node to a node within that subset is at most one hop. The distance to the remote sub-network is one, and the distance to a desired node within the remote sub-network is at most two. Thus, the maximum cross-network latency drops by one hop relative to the previous embodiment, from five hops to four hops, at a cost of increased wires and increased ports per router.

FIG. 10 shows an inter-network embodiment connecting a set of six simple 5-node Moore graphs. Each node in the 5-node sub-networks (a set of six sub-networks: sub-network 0 94, sub-network 1 96, sub-network 2 98, . . . sub-network 5 100) has two links to two nearest neighbors and lies at a distance of two hops from any other node in the sub-network. The sub-networks are connected in a manner to create the highly redundant Fishnet inter-network described above. Node 1 in sub-network 0 94 provides a connection to sub-network 1 96; node 2 in sub-network 0 94 provides a connection to sub-network 2 98; and so forth. Finally, node 5 in sub-network 0 94 provides a connection to sub-network 5 100. Similar connections are made in sub-networks numbered 1, 2, . . . 5 (elements 96, 98, . . . 100 respectively). Whereas in the previous embodiment of FIG. 7, node X in sub-network Y shares a physical connection with node Y in sub-network X, in this embodiment, the two nodes share a virtual connection, and the physical connections are made between the nearest neighbors of node X in sub-network Y and the nearest neighbors of node Y in sub-network X. In FIG. 10, the virtual connections are shown by dotted lines, and the physical connections are shown by solid lines.

The Moore graph embodiments connect n+1 sub-networks, each of which has n nodes in it; if each sub-network is built of n nodes with m ports each, then each sub-network has m redundant links connecting it to every other sub-network. For a given network of h maximum hops, m I/O ports per node for the board-area network, and m additional I/O ports on each node in the inter-board network, the rack-area network, containing boards 94, 96, 98, on up to the final board in the rack, 100. The rack-area network connects n+1 boards in a 2h hop network of n²+n nodes. Note that the latency is 2h and not 2h+1 as in the previous embodiment, because the maximum number of hops to reach an inter-sub-network link within the originating sub-network is by construction h−1, not h. Thus, the maximum number of hops is (h−1)+1+h, representing the maximum distance within the originating sub-network, the inter-network link, and the remote sub-network.

In the Petersen graph embodiments, each node has three I/O ports for the board-area network, and each node identifies a unique three-node subset. Therefore, each inter-board connection requires three links, not one. The increase is equal to the number of links used to construct the on-board network; so, the number of on-board links and off-board links is the same (three), and the number of redundant paths is also three. Thus, instead of ten wires leaving each board, as disclosed in previous embodiments, there would be three times that number of wires. But this embodiment, an example of which is shown in FIG. 10, provides a three-fold increase in reliability and a reduced number of maximum hops (four instead of five) when compared to the previous single-wire embodiment, for example of FIG. 7.

In an embodiment having 51 boards, with each board interconnected by a Hoffman-Singleton graph, each node would use seven I/O ports to implement the on-board network, and each node would have seven additional ports to implement the inter-board network. Each board would then have 350 off-board connections, and the network of 51 boards would have 2550 nodes, each node having a maximum of four hops to reach any other node on the entire network. Each pair of boards in the network connects with seven redundant links, so any single node or link failure would cause the maximum latency to increase for some connections, but it would not require traffic to be routed through other boards.

In a much larger embodiment, as described before, a Moore sub-network can be constructed of 1058 interconnected nodes, using 35 ports on each node to connect all 1058 nodes in a two-hop network. One can connect 1059 of these sub-networks together, for a total of 1,120,422 nodes. Each node identifies a nearest-neighbor subset of 35 nodes, and each of these nodes connects to the sub-network identified by the node in question (e.g., the nearest neighbors of node 898 would connect to nodes in sub-network 898). Thus, every node would require 70 ports total, and the network of 1,120,422 nodes would have a diameter, or maximum latency, of four hops. Pairs of sub-networks would be connected by 35 redundant links, which provide both a reduced latency of four hops, as compared to five hops of the “Lite” version above, and an increased reliability in the face of node or link failure, should any of the of 1,120,422 nodes or their connecting links fail.

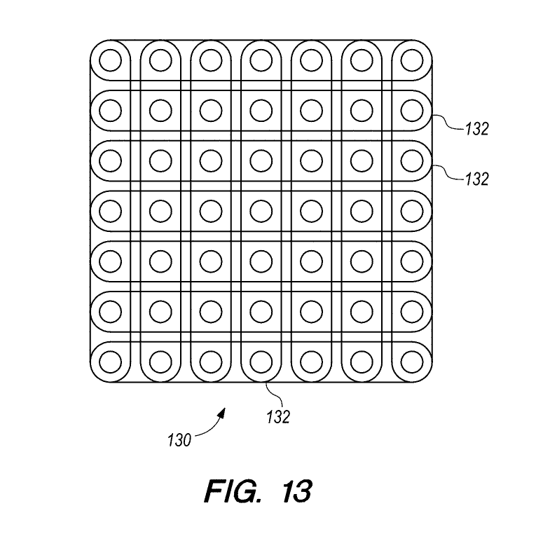

The Fishnet inter-network connection method works for sub-network topologies other than Moore graphs, as well. For example, in the prior art Flattened Butterfly network disclosed in FIG. 13, 130, nodes are connected in a fully-connected graph in each dimension: each row and column, some of which are indicated by arrows 132, is a fully-connected graph such that any member can access any other member in one hop. Thus, in a Flattened Butterfly network, each node lies at a maximum distance of 2 from any other node: maximum one hop in the X dimension, and maximum one hop in the Y dimension. Each fully connected graph means that every node in the graph is directly connected to each other. If we consider a Flattened Butterfly network of length n+1 on both sides (this is not a requirement in general; it is merely chosen for ease of explanation), then that network has (n+1)² nodes, and each node requires 2n ports. Each node can reach n nodes in each of the X and Y dimensions directly (in one hop).

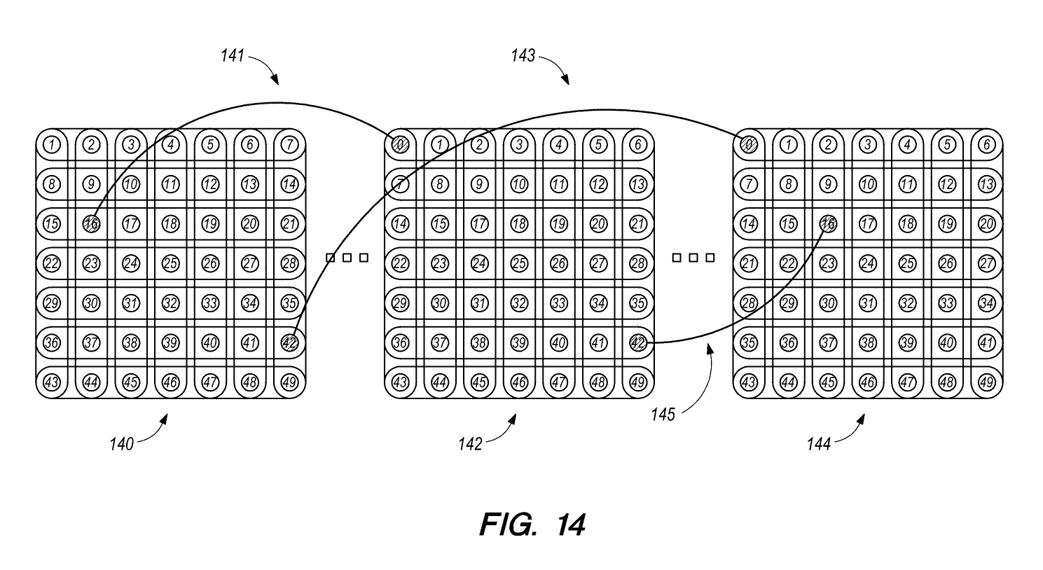

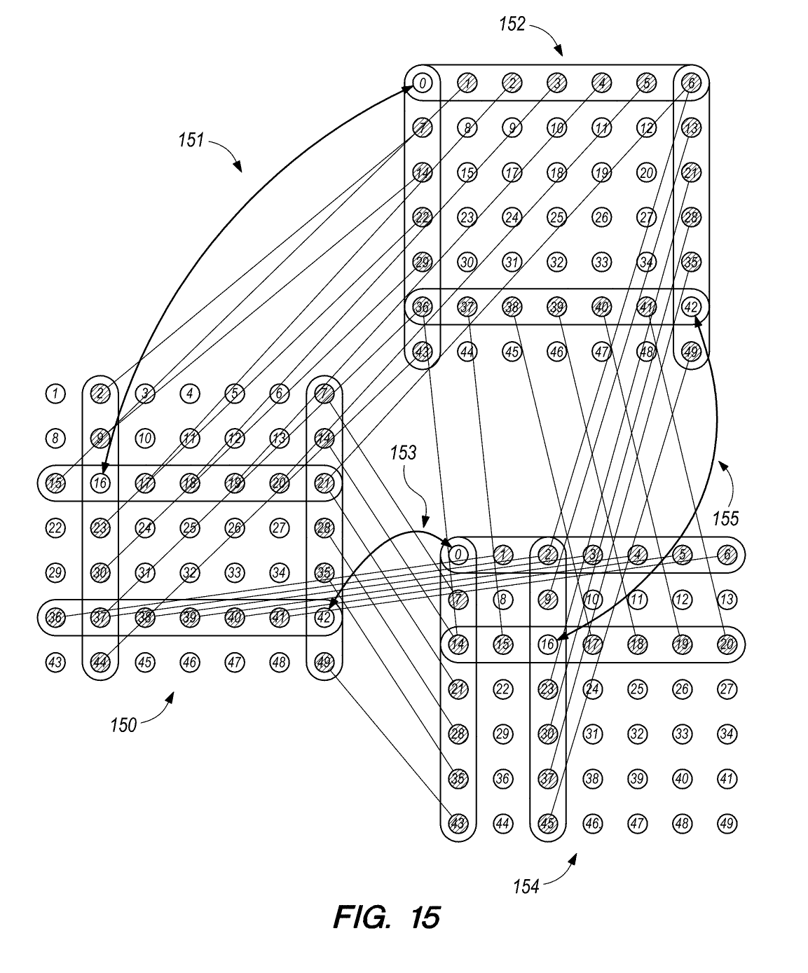

FIGS. 14 and 15 show the same two variations of the Fishnet inter-network of the present invention as described earlier within the context of Moore graphs; FIGS. 14 and 15 show “Lite” and regular examples based on a Flattened Butterfly network of 49 nodes. The Lite variation is shown in FIG. 14 and illustrates the same concept as the Moore-based inter-network shown in FIG. 7. The base network, a 7×7 Flattened Butterfly graph of 49 nodes, produces an inter-network of 50 sub-networks, and therefore a total of 2450 nodes, where each node uses 13 ports. Just as in the previous examples, the nodes of each sub-network 140, 142, 144 are numbered such that there is no node in the sub-network that has the same number as the sub-network. FIG. 14 shows three randomly selected sub-networks: sub-network 0 140, sub-network 16 142, and sub-network 42 144. The nodes of sub-network 0 140 are numbered 1 . . . 49. The nodes of sub-network 16 142 are numbered 0 . . . 15, 17 . . . 49. The nodes of sub-network 42 144 are numbered 0 . . . 41, 43 . . . 49.

FIG. 14 also shows the same topology of connections as in the previous example using Moore graphs: node 16 of sub-network 0 140 connects to node 0 of sub-network 16 142 through link 141. Node 42 of sub-network 0 140 connects to node 0 of sub-network 42 144 through link 143. Node 42 of sub-network 16 142 connects to node 0 of sub-network 42 144 through link 143. The maximum latency in this inter-network is five hops: a maximum of two hops in the originating sub-network, one inter-sub-network hop, and a maximum of two hops in the remote sub-network. So the number of ports required per node is 1 more than the Flattened Butterfly sub-network requires (in this case, 12+1=3 ports per node), and the maximum hop-latency through the full inter-network is five hops.

The embodiment in FIG. 14 requires 13 router ports: 6 to connect with the local nodes in the X dimension, 6 to connect with the local nodes in the Y dimension, and one more port to connect to a remote node.

FIG. 15 shows the highly redundant Fishnet inter-network with reduced maximum latency, using 50 7×7 Flattened Butterfly sub-networks of 49 nodes each. As with the FIG. 14 embodiment, sub-networks 0, 16, and 42 are shown (150, 152, and 154, respectively). The nodes of each sub-network 150, 152, and 154 are numbered such that there is no node in the sub-network that has the same number as the sub-network. The nodes of sub-network 0 150 are numbered 1 . . . 49. The nodes of sub-network 16 152 are numbered 0 . . . 15, 17 . . . 49. The nodes of sub-network 42 154 are numbered 0 . . . 41, 43 . . . 49.

Unlike the FIG. 14 embodiment, instead of using the numbered node to connect each sub-network pair, we use the numbered node to identify a unique subset that will connect to the identified remote sub-network. Because each of these two-hop subsets is at a distance of one less than the maximum hop distance from all other nodes (in this example, one less than 2), this effectively reduces the cross-network latency by one.

In the Flattened Butterfly network embodiment, the maximum distance within the sub-network is two, by definition. A maximum two-hop subset is defined for each remote sub-network. For each maximum two-hop subset, the distance from any node to that subset is at most one hop. The distance to the remote sub-network is one, and the distance to a desired node within the remote sub-network is at most two. Thus, the maximum cross-network latency drops by one hop relative to the previous embodiment, from five hops to four hops, at a cost of increased wires and increased ports per node.

FIG. 15 shows an inter-network embodiment connecting a 50-member set of 49-node Flattened Butterfly graphs. Each node in the 49-node sub-networks 150, 152, . . . 154 has 12 links to 12 nearest neighbors and lies at a distance of two hops from any other node in the sub-network. The sub-networks are connected in a manner to create the highly redundant inter-network described above. Node 16 in sub-network 0 150 provides a connection to node 0 in sub-network 16 152 through virtual connection 151; node 42 in sub-network 0 150 provides a connection to node 0 in sub-network 42 154 through virtual connection 153; and so forth. Finally, node 42 in sub-network 16 152 provides a connection to node 16 in sub-network 42 154 through virtual connection 155. Similar connections are made in sub-networks numbered 1 . . . 15, 17 . . . 41, 43 . . . 49. Whereas in the previous embodiment of FIG. 14, node X in sub-network Y shares a physical connection with node Y in sub-network X, in this embodiment, the two nodes share a virtual connection (illustrated by links 151, 153, and 155), and the physical connections are made between the nearest neighbors of node X in sub-network Y and the nearest neighbors of node Y in sub-network X. In FIG. 15, the virtual connections are shown by thick lines with arrows on each end, and the physical connections are shown by straight thin lines.

These embodiments connect n+1 sub-networks, each of which has n nodes in it; if each sub-network is built of n nodes with m ports each, then each sub-network has m redundant links connecting it to every other sub-network. For a given sub-network of h maximum hops, m I/O ports per node for the board-area network, and m additional I/O ports on each node in the inter-board network, the rack-area or system-area network connects n+1 boards in a 2h hop network of n²+n nodes. Note that the latency is 2h and not 2h+1 as in the previous embodiment, because the maximum number of hops to reach an inter-sub-network link within the originating sub-network is by construction h−1, not h. Thus, the maximum number of hops is (h−1)+1+h, representing the maximum distance within the originating sub-network, the inter-network link, and the remote sub-network.

In the 7×7 Flattened Butterfly graph embodiments, each node has twelve (6+6=12) I/O ports for the board-area network, and each node identifies a unique twelve-node subset. Therefore, each inter-board connection requires twelve links, not one—the increase is equal to the number of links used to construct the on-board network; so, the number of on-board links and off-board links is the same (twelve), and the number of redundant paths is also twelve. Thus, the number of ports per node and the number of wires between each subnet/board is larger than in the previous example. But this embodiment provides a twelve-fold increase in reliability and a reduced number of maximum hops (four instead of five), relative to the embodiment disclosed in FIG. 14.

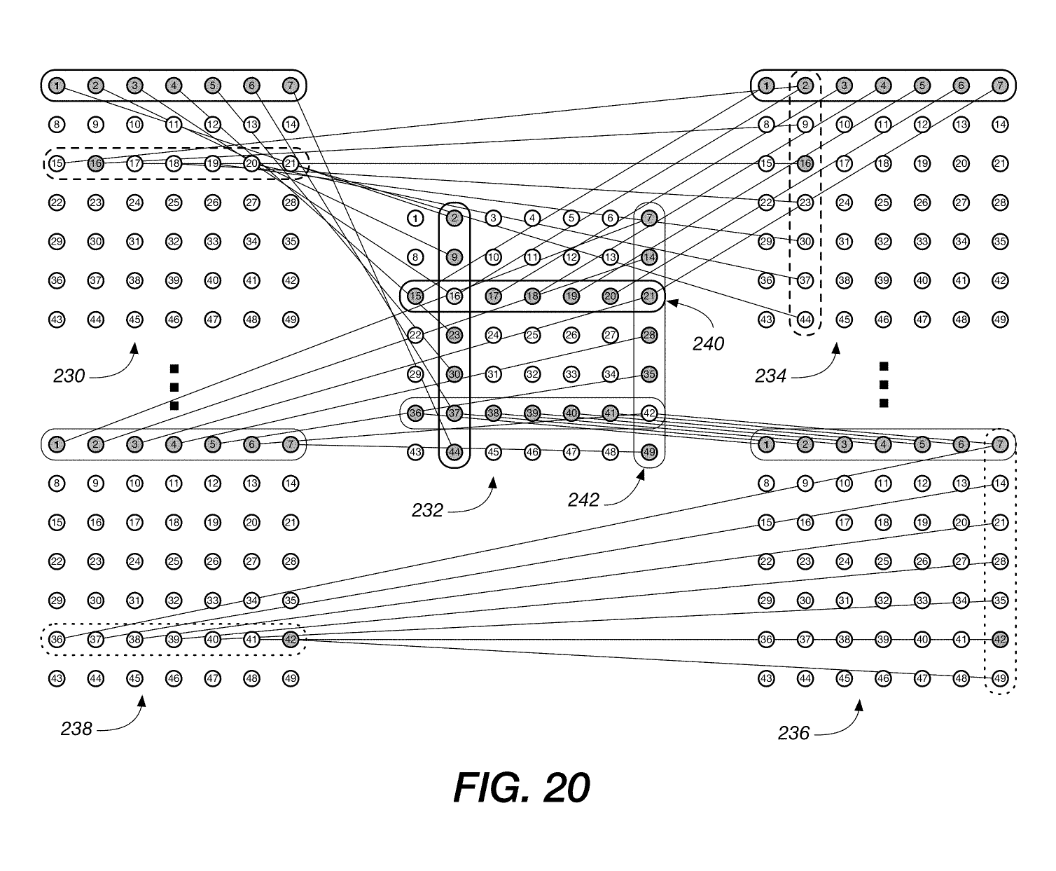

FIG. 20 gives a second example of connecting sub-networks in a regular Fishnet configuration. Fishnet interconnects identify subsets of nodes within each sub-network that are reachable within a single hop from all other nodes: Flattened Butterflies have numerous such subsets, including horizontal groups, vertical groups, diagonal groups, etc. The example in FIG. 20 uses horizontal and vertical groups: the total network contains 98 sub-networks, numbered 1H . . . 49H and 1V . . . 49V. Five sub-networks are shown: sub-networks 16V 230 and 16H 234, sub-networks 42V 238 and 42H 236, and sub-network 1H 232 in the center. When contacting an “H” sub-networks, one uses any node in the horizontal row containing that numbered node. For example, to communicate from a node in sub-network 1H 232 to a node in sub-network 16H 234, one first connects to any node in the horizontal row 240 in sub-network 1H 232 that contains node 16. To communicate from a node in sub-network 1H 232 to a node in sub-network 42V 238, one first connects to any node in the vertical column 242 in sub-network 1H 232 that contains node 42.

Given that Flattened Butterfly networks are constructed out of fully connected graphs in both horizontal and vertical dimensions, this means that one can reach a remote sub-network in at most two hops. From there, it is a maximum of two hops within the remote sub-network to reach the desired target node. For a Flattened Butterfly sub-network of N×N nodes, one can build a system of 2N4 nodes using vertical and horizontal groups; this can be extended further by allowing diagonal sets as well. In addition, 2D Flattened Butterflies have two shortest paths connecting each node within a sub-network, which potentially makes for more efficient congestion avoidance than Angelfish designs.

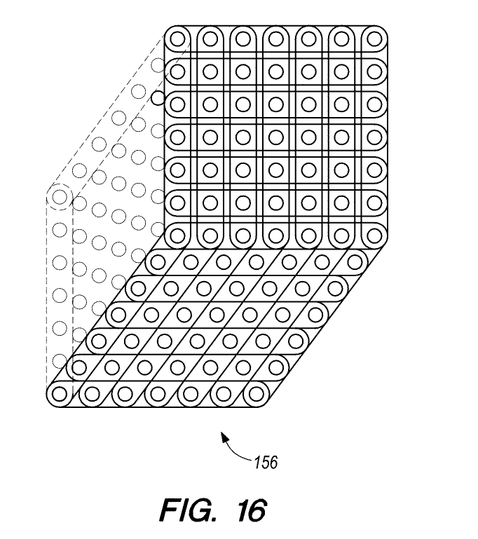

The prior art Flattened Butterfly interconnect topology in FIG. 13, 130, has all nodes in fully connected graphs 132. This topology provides a regular structure for a two-hop network, which is beneficial compared to the disclosed Moore networks, but it comes at an increased cost in ports per router. However, the disclosed embodiment in FIG. 16 expands the 2D Flattened Butterfly topology to three dimensions 156 and is capable of even higher dimensions.

The Fishnet interconnect connects multiple copies of regular sub-networks like the 2-hop Moore graphs disclosed above. The Fishnet interconnects provide a 2-hop sub-network of n nodes, each with p ports. The Fishnet constructs a system of n+1 sub-networks, in two ways: the first uses p+1 ports per node and has a maximum latency of five hops within the system; the second uses 2p ports per node and has a maximum latency of four hops.

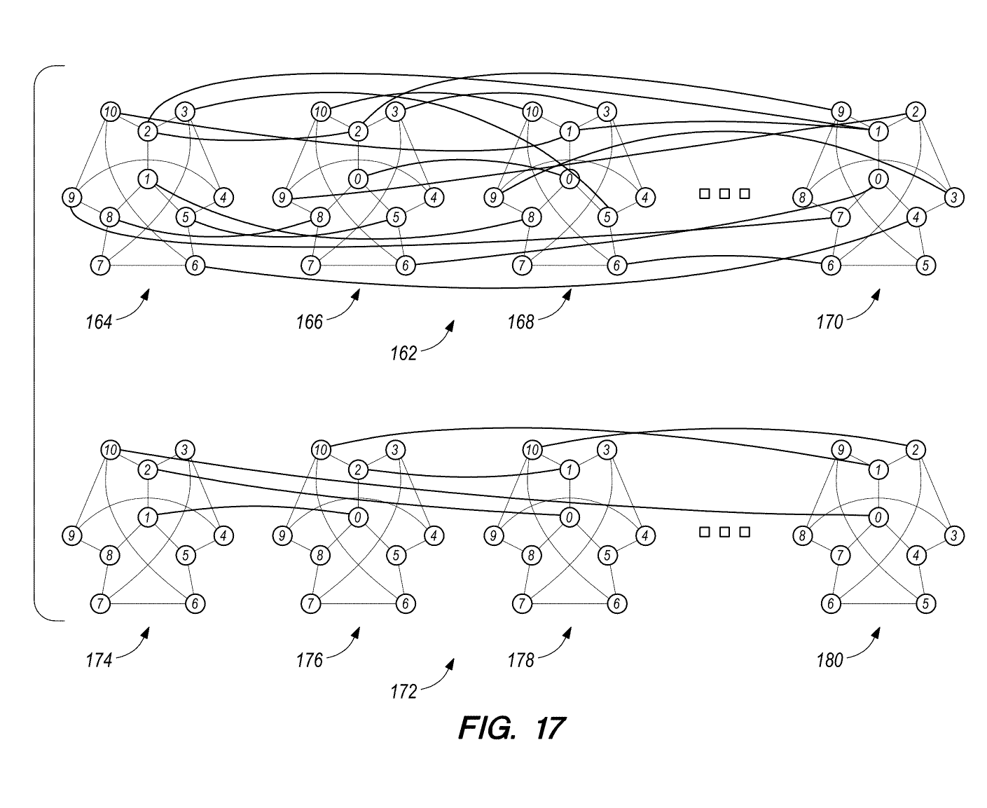

Angelfish network embodiments FIG. 17, 162, 172 combine Moore sub-networks using the Fishnet interconnect. Angelfish interconnects, FIG. 17, is a type of “fishnet” interconnect, interconnecting sub-networks of the same type like the interconnected Moore graphs 162, 172 disclosed in FIG. 17.

The Angelfish Lite embodiment of the fishnet interconnect FIG. 17, 172 use a single link to connect each sub-network. In the FIG. 17 embodiment of the Angelfish Lite interconnect, sub-network 0 has nodes numbered 1 . . . 10, 174; sub-network 1 has nodes numbered 0, 2 . . . 10, 176; sub-network 2 has nodes numbered 0, 1, 3 . . . 10, 178; etc. And sub-network 10 has nodes numbered 0 . . . 9, 180. There is a connection between sub-network X, node Y and sub-network Y, node X. Given sub-networks of size n with maximum latency of 2, this creates a network of n²+n nodes, a maximum latency of 5, and a port cost of 1 on top of the ports required to construct the subnet.

The Petersen graph embodiments disclosed above use 3 ports per node and have 10 nodes, all reachable in 2 hops; the Angelfish Lite network 172 based on the Petersen graph has 110 nodes, all reachable in 5 hops, and uses 4 ports per node. The Hoffman-Singleton graph disclosed above uses 7 ports per node and has 50 nodes, all reachable in 2 hops. Thus, an Angelfish Lite network embodiment, based on a Hoffman-Singleton graph, would have 2550 nodes, all reachable in 5 hops, and uses 8 ports per node.

The limitation of the Angelfish Lite embodiment is the single link per subnet. If this single link goes down, traffic between the affected sub-networks would be routed through other sub-networks, degrading network performance significantly. However, the full version of the Angelfish FIG. 17, 162 solves this by connecting each pair of sub-networks with m links, where m is the number of ports per node, used to construct the subnet: i.e., the full Angelfish embodiment doubles the ports per router. FIG. 17, 162 disclosed an Angelfish network based on the Petersen graph.

Instead of connecting sub-network X, node Y and sub-network Y, node X, the Angelfish embodiment connects the nearest neighbors of sub-network X, node Y to the nearest neighbors of sub-network Y, node X. This provides the interconnect with two advantages: first, redundant links connect each pair of sub-networks, and second, it reduces the maximum latency by one. Because a nearest neighbor subset is chosen to connect sub-network X to sub-network Y, any node in sub-network X wishing to send a packet to sub-network Y can reach one of the connecting nodes in a single hop, which would have required two hops in the Angelfish Lite embodiment FIG. 17, 172. Thus, the total end-to-end maximum latency is four (4) router hops. For example, the Petersen graph uses 3 ports per node and has 10 nodes, all reachable in 2 hops; the Angelfish network based on the Petersen graph has 110 nodes, all reachable in 4 hops, and uses 6 ports per node. The Hoffman-Singleton graph uses 7 ports per node and have 50 nodes, all reachable in 2 hops. An Angelfish network based on the Hoffman-Singleton graph has 2550 nodes, all reachable in 4 hops, and uses 14 ports per node.

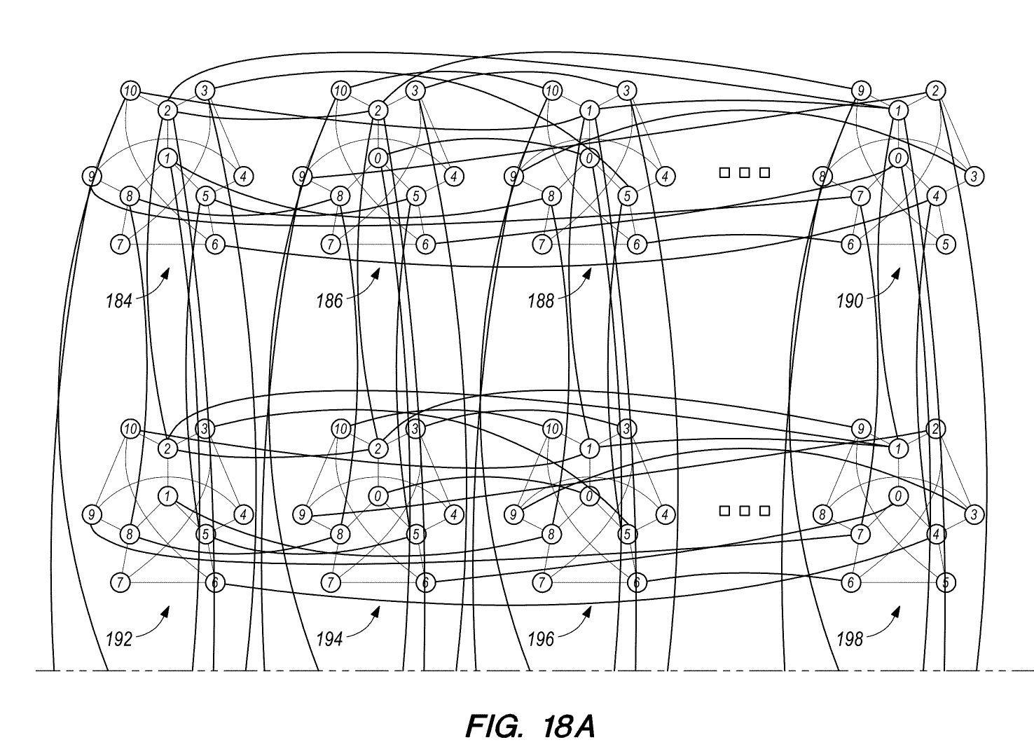

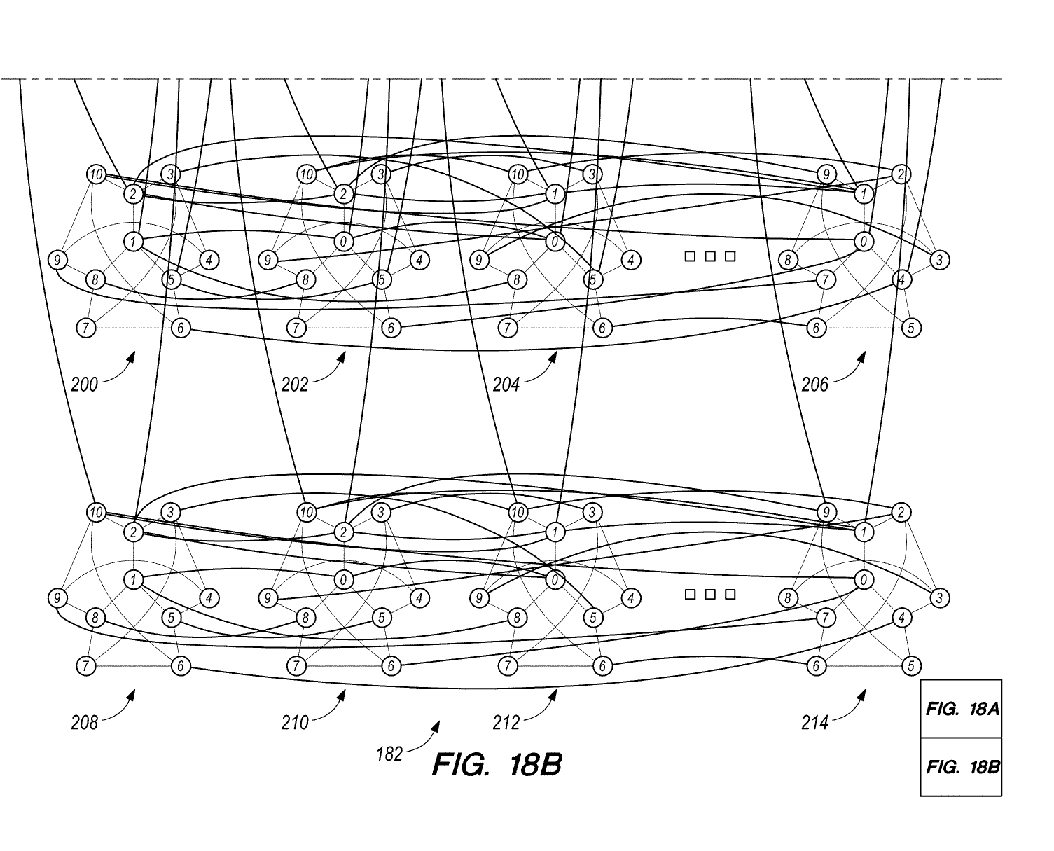

A “mesh” embodiment of the Angelfish interconnect, FIGS. 18A and 18B, 182, like the higher-dimensional torus and Flattened Butterfly networks, discloses the Angelfish network as an effective 1D network, but the Angelfish “mesh” interconnect embodiment in FIGS. 18A and 18B, 182 is an extension of the Angelfish interconnect FIGS. 17 to 2D.

Given an n-node sub-network of two hops, with m ports per router, this produces a network of n(n+1)² nodes, 3m ports per router, and a maximum latency through the system of 6 hops. The Petersen graph embodiments 184, 186, 188, 190, 192, 194, 196, 198, 200, 202, 204, 206, 208, 210, 212, 214 use 3 ports per node and have 10 nodes, all reachable in 2 hops. The Angelfish Mesh network of FIGS. 18 A and B, based on the Petersen graph, has 1210 nodes with all nodes reachable in 6 hops, and each node has 9 ports. The Hoffman-Singleton graph uses 7 ports per node and has 50 nodes, all reachable in 2 hops. The Angelfish Mesh network FIGS. 18A and 18B, 182 based on the Hoffman-Singleton graph has 130,050 nodes, all reachable in 6 hops, and uses 21 ports per node.

The Fishnet interconnect can combine sub-networks other than Moore graphs. In one disclosed embodiment, the Fishnet connects Flattened Butterfly sub-nets, producing “Dragonfish” networks. These networks have two disclosed embodiments. FIG. 14 discloses a Dragonfish Lite network 140, 142, 144 based on 7×7, 49-node Flattened Butterfly sub-networks. The same numbering scheme is used as in previous embodiments: for all sub-networks X from 0 to 49 there is a connection between sub-network X, node Y and sub-network Y, node X, 141, 143, 145. The result is a 2450-node network with a maximum 5-hop latency and 13 ports per node.

FIG. 15 discloses a full, or complete set of Dragonfish networks 150, 152, 154 interconnected by the Fishnet interconnect 151, 153, 155. Thus, the full Fishnet interconnect 151 153, 155, of the Dragonfish networks 150, 152, 154 have 98 sub-networks, numbered 1H . . . 49H and 1V . . . 49V. When contacting an “H” subnet, one uses any node in the horizontal row containing that numbered node 151. Thus, to communicate from sub-net 1H to sub-network 16H, one connects to any node in the horizontal row containing node 16 155. To communicate from sub-network 1H to sub-network 42V, one connects to any node in the vertical column containing node 42 153. Since fully constructed Flattened Butterfly networks have fully connected graphs in both horizontal and vertical dimensions, one can reach a remote sub-network in at most two hops. From there, it is a maximum of two hops within the remote sub-network to reach the desired target node. For a Flattened Butterfly sub-network of N×N nodes, one can build a system of 2N4 nodes with 4N−2 ports per node and a maximum latency of 4 hops. Flattened Butterfly sub-network interconnects can also be extended further by allowing diagonal sets.

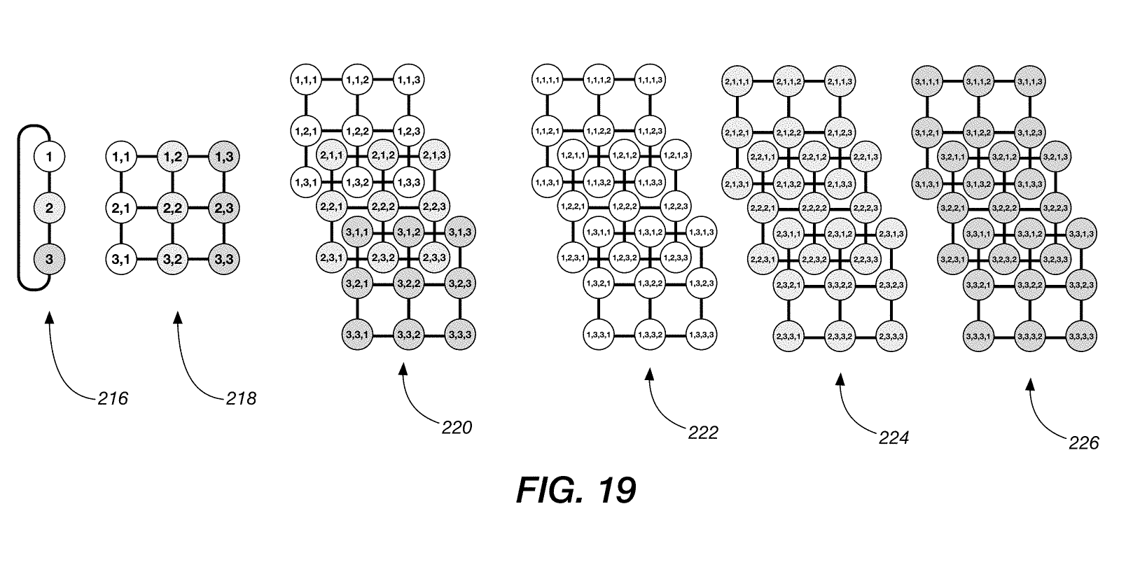

Additionally, FIG. 19 shows a sequence of torus organizations with length of 3 per side, starting at 1D 216 and going up to 4D 226; consistent with torus organization, each node has two ports pointing in opposite directions in a given dimension. This can be seen in the first example of a 1D torus: a simple ring 216. Then the 1D torus 216 is expanded to 2D 218 (at which point the wrap-around links are no longer shown, to make the illustrations readable), which is a 1D torus replicated 3 times in a new dimension, and each node has two ports pointing in opposite directions in the second dimension. The 3D torus 220 is the 2D torus 218 replicated 3 times in yet another dimension, and each node has two ports pointing in opposite directions in the third dimension. At this point, the links connecting the network subsets are no longer shown, to make the illustrations readable. The 4D torus 222, 224, 226 is the 3D torus 220 replicated 3 times in yet another dimension, and each node has two ports pointing in opposite directions in the fourth dimension. Each of the subsets 222, 224, 226 is a copy of the 3D torus 220, and when they are attached via their connecting links, together they become a single 4D torus of 3 nodes per side. This process can scale upwards indefinitely, limited only by physical constraints on ports and space.

Finally, FIG. 20 discloses an embodiment of connected sub-networks in a regular Fishnet configuration. Fishnet interconnects identify subsets of nodes within each sub-network that are reachable within a single hop from all other nodes: Flattened Butterflies have numerous such subsets, including horizontal groups, vertical groups, diagonal groups, etc. The example in FIG. 20 uses horizontal and vertical groups: the total network contains 98 sub-networks, numbered 1H . . . 49H and 1V . . . 49V. Five sub-networks are shown: sub-networks 16V 230 and 16H 234, sub-networks 42V 238 and 42H 236, and sub-network 1H 232 in the center. When contacting an “H” sub-networks, one uses any node in the horizontal row containing that numbered node. For example, to communicate from a node in sub-network 1H 232 to a node in sub-network 16H 234, one first connects to any node in the horizontal row 240 in sub-network 1H 232 that contains node 16. To communicate from a node in sub-network 1H 232 to a node in sub-network 42V 238, one first connects to any node in the vertical column 242 in sub-network 1H 232 that contains node 42.

Given that Flattened Butterfly networks are constructed out of fully connected graphs in both horizontal and vertical dimensions, this means that one can reach a remote sub-network in at most two hops. From there, it is a maximum of two hops within the remote sub-network to reach the desired target node. For a Flattened Butterfly sub-network of N×N nodes, one can build a system of 2N⁴ nodes using vertical and horizontal groups; this can be extended further by allowing diagonal sets as well. In addition, 2D Flattened Butterflies have two shortest paths connecting each node within a sub-network, which potentially makes for more efficient congestion avoidance than Angelfish designs.

Routing and Failures

Addressing in the disclosed embodiments, and both the Moore and Flattened Butterfly inter-networks, could be via either static or dynamic routing. The following is the dynamic routing embodiment.

In an initialization phase, each node builds up a routing table with one entry for each node in the system, using a minor variant of well-known algorithms. There are two possible algorithms: one for full Moore-graph topologies, and another for inter-network topologies, as described above.

First example assumes a full Moore graph of p ports and k hops, rack-wide. The routing-table initialization algorithm requires k phases, as follows:

| | |
|---|---|
| phase 1: | send ID to each nearest neighbor |
| | upon receiving p IDs, update table to reflect topology: |
| | foreach ID { table[ID] = port p } |
| phase 2: | send IDs in table to each nearest neighbor |
| | upon receiving p ID sets, update table to reflect topology: |
| | foreach ID { if table[ID] empty, table[ID] = port p } |
| . . . | |
| phase k: | send IDs table to each nearest neighbor |
| | upon receiving p ID sets, update table to reflect topology |
| | foreach ID { if table[ID] empty, table[ID] = port p } |

At each phase, each node receives p sets of IDs, each set on one of its ports p. This port number represents the link through which the node can reach that ID. The first time a node ID is seen represents the lowest-latency link to reach that node, and so if a table entry is already initialized, it need not be initialized again (doing so would create a longer-latency path).

For the single-wire or redundant-wire inter-board network embodiments, as disclosed above, the table-initialization algorithm takes known remote-boards into account. For a board-level topology of n nodes, each of which has p ports, the 2-hop network embodiment would be suitable. Thus, the table-initialization algorithm requires two phases to initialize the entire rack network. This is because, in this type of network, each node ID contains both a board ID and a node ID unique within that board. The algorithm:

| | |
|---|---|
| phase 1: | send ID [board #, node #] to each nearest neighbor |
| | upon receiving p IDs, update table to reflect topology: |
| | foreach ID |

if ID is on local board

table[ID] = port p

else

b = board number for node ID
for all nodes n on board b, table[n] = p

| | |
|---|---|
| phase 2: | send nearest-neighbor IDs only to neighbors on same board |
| | upon receiving p ID sets, update table to reflect topology: |
| | foreach ID |

if ID is on local board

if table[ID] empty, table[ID] = port p

else

b = board number for node ID
for all nodes n on board b, table[n] = p

Because the inter-board connections are limited in this network topology there are only a limited subset of nodes on each board directly connecting to other boards on the network.

During operation, system-level routing is hierarchical: a node's address is unique within the system and specifies the sub-network number and the node number within the sub-network. When a router receives a packet, it looks at the sub-network ID in the packet; if it is local, it uses the routing table described above to decide which port to use, often the port identified by the algorithm as the one producing the shortest path to reach the node. If the the sub-network ID does not match the ID of the local sub-network, the router forwards the packet to a node that has a connection to the remote sub-network. Assume that the remote sub-network has the ID of “X”. In the “Lite” versions of Fishnet, reaching remote sub-network “X” means first sending the packet to local node X. That is done by the method described above of routing to a local node. In the normal versions of Fishnet, reaching remote sub-network X means first sending the packet to one of the nearest neighbors of local node X. If the router is itself a nearest neighbor of local node X, it has the link to the remote sub-network and sends the packet out that port. If the router is not a nearest neighbor of local node X, then it is one hope away from a nearest neighbor of local node X, and it can reach one of those nodes by routing the packet to local node X. As described above, the routing table initialization algorithm finds the shortest path, and so that shortest path will reach a neighbor of local node X in one hop.

In the case of congestion, any of the existing routing schemes can be used, and because these are very high-radix networks with many redundant connections between nodes, even mechanisms such as, in the face of a congested link, routing the packet one hop in a random direction will work well.

In the case of node/link failures for each of the system topologies, when a node realizes that one of its links is dead (there is no response from the other side), it broadcasts this fact to the system, and all nodes update their table temporarily to use random routing when trying to access the affected nodes. The table-initialization algorithm is re-run as soon as possible, with extra phases to accommodate for the longer latencies that will result with one or more dead links. If the link is off-board in the large-scale topology, then the system uses the general table-initialization algorithm of the small-scale system.

Because of the regularity of these networks, static routing can be also used, which for example, can be seen in the regular board designs of FIG. 6 as well as the regular sub-network topologies shown in FIGS. 5, 7, 10, 14, and 15.

The disclosed graph network topologies have link redundancies similar to other network topologies such as meshes. When a link goes down, all nodes in the system are still reachable, but the latency simply increases for a subset of the nodes. One can see this in the Petersen graph embodiment in FIG. 11. If the link between the center node 0 and node 2 goes down 102, the latency from those nodes increases but the rest of the graph is unaffected. When sending to or from node 2, the only nodes affected are node 0, and its remaining nearest neighbors 104. When sending to or from node 0, the only nodes affected are node 2 and its nearest neighbors 106. Communication to and from all the other nodes proceeds as normal, with the normal latency. Thus, during link failure, the affected nodes simply require an additional hop, or two in the case of sending between the two nodes immediately adjacent to the failed link (e.g., as seen in 104 and 106).

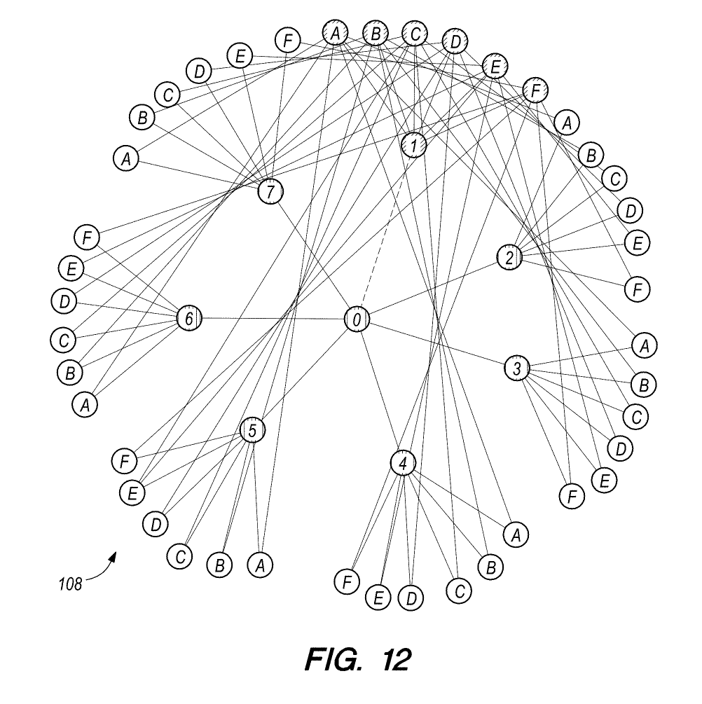

Additionally, the overhead in the disclosed embodiments of the Moore graph networks is relatively low. FIG. 12 shows this on a large-scale graph. The Hoffman-Singleton graph 108 in FIG. 12 shows a cut link between nodes 0 and 1. Node 1 and its remaining nearest neighbors are shaded, as are node 0 and its remaining nearest neighbors. Node 0 is still connected in two hops to every node but node 1 and the A-F nodes that are nearest neighbors to node 1 (all shaded). Node 1 is still connected in two hops to every node but node 0 and nodes 2 to 7, the nearest neighbors to node 0.

The 36 remaining nodes, labeled A to F (not shaded) have not been affected. Similarly, communications between the nearest neighbors of node 0 and the nearest neighbors of node 1 have not been affected. Only communications involving either node 0 or node 1 are affected: communication between node 0 and 1 can take any path out of node 0 or node 1 (using random routing in the case of link failure) and the latency increases from 2 hops to 4. Communications between node 0 and the remaining nearest neighbors of 1, or between node 1 and the remaining nearest neighbors of 0, requires three hops; similarly communication between nodes 0 and 1, it can be take by any path, for example, to get from node 0 to node A in node 1's neighbors (the shaded node A), goes through either nodes 2, 3, 4, 5, 6 or 7, and still requires only a latency of three hops.

Although the present invention has been described with reference to the disclosed embodiments, numerous other features and advantages of the present invention are readily apparent from the above detailed description, plus the accompanying drawings, and the appended claims. Those skilled in the art will recognize that changes may be made in form and detail without departing from the spirit and scope of the disclosed invention.

What I claim is:

1. A multiprocessing network, comprising:
multiple processing nodes, each node having multiple ports;
the ports connecting their node to the ports of other processing nodes;
the network divided into sub-networks, each sub-network having substantially the same topology so that one sub-network circuit-board design can be used for all sub-networks; and
the sub-networks connected in a scalable Moore graph network topology.

2. The multiprocessor computer system of claim 1, further comprising:
a hierarchical routing table at each node;
a routing table initialization algorithm at each node;
the initialization algorithm initializes the hierarchical routing table at each node, the hierarchical routing table identifying a port number for each node in the local sub-network, and the hierarchical routing table identifying a node in the local sub-network for each remote sub-network.

3. The multiprocessor network of claim 2, further comprising:
a network routing algorithm at each node in the network;
the routing algorithm maintains and updates the hierarchical routing table with the shortest possible latency between the interconnected nodes of the multiprocessor network.

4. The multiprocessor network of claim 3, further comprising:
a failed node recovery routine at each node;
the failed node recovery routine marking the node-ID of unresponsive nodes in the Moore graph routing table;
broadcasting the unresponsive node-ID to all nodes in the multiprocessor network; and
all nodes running the routing table initialization algorithm again, updating the hierarchical routing table to route around the failed node.

5. The multiprocessing network of claim 4, further comprising:
a scalable printed circuit board (PCB)-level sub-network of processing nodes interconnected in the scalable Moore network topology.

6. The multiprocessing network of claim 4, further comprising:
n number of input and output (I/O) ports per node;
each node connected to an immediate neighborhood of a n-node subset of nodes;
each node having one hop to communicate with each node in the n-node subset of nodes; and
two hops to communicate the other nodes in the Moore graph sub-network of interconnected nodes.

7. The multiprocessor network of claim 6, wherein all the processor nodes on the PCB are interconnected in a Petersen graph network topology.

8. The multiprocessing network of claim 1, further comprising:
a scalable, multi-rack level network of interconnected nodes, interconnected PCBs, and interconnected racks, in a multi-layered network of Moore graph sub-networks;
the Moore graph sub-networks having substantially similar design such that they can use the same PCB design; and
the Moore graph sub-networks having a maximum intra-network latency between processor nodes of two hops; and
the scalable, multi-rack level network of interconnected nodes, interconnected PCBs, and interconnected racks having a maximum intra-network latency between processor nodes of four hops; and
the multi-layered network of Moore graph sub-networks having a hierarchy of routing tables for the multi-node, multi-PCB, and multi-rack area networks.

9. The multiprocessing network of claim 8, further comprising:
each node in the scalable multi-rack area network connected to a different remote PCB, in a different rack, in the multi-layered network of Moore graph sub-networks.

10. The multiprocessor network of claim 9, wherein each sub-network is a Petersen graph network; and a Hoffman-Singleton graph interconnects all the sub-networks of the multi-layered network of Moore graph sub-networks.

11. The multiprocessing network of claim 9, further comprising:
a hierarchy of table-initialization algorithms for each node, PCB, rack, and the multi-rack Moore graph networks in the multi-layered network of Moore graph sub-networks; and
a failed node recovery algorithm at each level in the multi-layered network of Moore graph sub-networks resets the routing tables when any layer in the multi-rack Moore graph networks fails;
updating the routing table with a failed node, PCB, rack, and multi-rack routing tables, depending on which component, at which level in the multi-rack Moore graph networks fails.

12. A large-scale multiprocessor computer system, comprising:
multiple processing nodes;
multiple PCB boards having an identical layout;
the multiple processing nodes on each PCB board interconnected in a Moore graph network topology;
each PCB fitting into a server-rack, creating a multiple PCB server-rack network topology.

16. The large-scale multiprocessor computer system of 12, further comprising:
a Fishnet interconnect rack-area network interconnects the multiple PCBs.

17. The multiprocessor computer system of claim 12, wherein each node constructs a routing table having one entry for each node in the local sub-network.

18. The multiprocessing network of 12, further comprising:
a microprocessor and memory at each processing node;
the microprocessor having direct access to the memory of the node;
each microprocessor having its memory mapped into a virtual memory address space of the large-scale multiprocessor computer network of interconnected processing nodes.

19. A method of recovering from a node failure in a multiprocessor computer system configured in a multi-layered network of Moore sub-networks, all the sub-networks interconnected in a Moore graph network topology, and each node of the multiprocessor computer system having a router, a routing algorithm, and a routing table, the method comprising the steps of:
marking a node-ID as a failed node when a sending-node fails to receive an expected response from a receiving node;
the sending-node broadcasting the node-ID of the failed node to its sub-network;
all nodes in the sub-network updating their routing table and using random routing until the table-initialization algorithm at each node resets its routing table.

20. A Fishnet multiprocessor interconnect topology comprising:
multiple copies of similar sub-networks;
the Fishnet interconnect topology connecting the sub-networks;
each sub-network having a 2-hop latency between the n nodes of the sub-network; and
a system-wide diameter of 4 hops.

21. The Fishnet multiprocessor network topology of claim 20 wherein the sub-networks are 2-hop Moore graphs.

22. The Fishnet multiprocessor network topology of claim 20 wherein the sub-networks are Flattened Butterfly sub-networks.

23. A Fishnet multiprocessor network topology interconnecting Flattened Butterfly sub-networks of N×N nodes, the Fishnet network interconnect having 2N⁴ nodes, 4N−2 ports per node, and a maximum latency of 4 hops.

24. A multidimensional set of Flattened Butterfly sub-networks having over three-dimensions; and
every dimension having a fully connected graph.

25. A multidimensional torus network having higher than three dimensions, the length of a linear chain of connected nodes in any dimension is substantially the same, and all dimensions are substantially symmetric in their organization.

26. An Angelfish network interconnect topology comprising:
the Angelfish network interconnects sub-networks of the same type, each sub-network using p ports per node, each sub-network having n nodes, and each sub-network having a diameter of 2 hops;
each pair of sub-networks interconnected with p links creating redundant links between each pair of sub-networks; and
the diameter of the Angelfish network is 4 hops.

27. The Angelfish network interconnect topology of claim 26 wherein the sub-networks are nodes connected in a Petersen graph network topology.

28. The Angelfish network interconnect topology of claim 26 wherein the nodes of the sub-networks are interconnected in a Hoffman-Singleton graph network topology.

29. A multidimensional Angelfish Mesh interconnect topology, comprising:
multiple sub-networks having n-nodes and a latency of two hops;
each sub-network having m ports per router; and
the multidimensional Angelfish mesh interconnect topology having n(n+1)² nodes, 3m ports per router, and a maximum latency throughout the multidimensional Angelfish mesh interconnect of 6 hops.

30. An Angelfish Mesh network interconnect topology of claim 29 wherein the interconnected nodes of the sub-networks are Petersen graph networks.

31. An Angelfish Mesh network interconnect topology of claim 29 wherein the interconnected nodes of the sub-networks are interconnected in a Hoffman-Singleton graph network.

32. A multiprocessing network, comprising:
multiple processing nodes, each node having multiple ports;
the ports connecting their nodes to the ports of other processing nodes;
the interconnected nodes connected in a scalable network topology;
the network divided into sub-networks, each sub-network having substantially the same sub-network topology;
each sub-network circuit-board design substantially the same for all sub-networks; and
a Moore graph network topology connecting the nodes in each sub-network.

33. The multiprocessing network of claim 32, further comprising:
n number of input and output (I/O) ports per node;
m number of nodes within sub-networks of the multiprocessing network;
each node connected to an immediate neighborhood of a n-node subset of nodes within the sub-networks;
each node having one hop to communicate within the n-node immediate neighborhood of nodes; and
two hops to communicate with the m nodes of the sub-network of that node.

34. The multiprocessing network of claim 32, further comprising:
n additional number of input and output (I/O) ports per node;
each port connected to the port of a node in a remote sub-network;
the multiprocessing network having m(m+1) nodes; and
the multiprocessing network having a diameter of 4 hops.

35. The multiprocessing network of claim 32, further comprising:
1 additional input and output (I/O) ports per node;
the additional port connected to the port of a node in a remote sub-network;
the entire network having m(m+1) nodes; and
the entire network having a diameter of 5 hops.

36. The multiprocessing network of claim 32, further comprising:
2n additional input and output (I/O) ports per node;
each port connected to the port of a node in a remote sub-network; and
the multiprocessing network having m(m+1)² nodes, and a diameter of 6 hops.

37. The multiprocessing network of claim 32, further comprising:
2 additional input and output (I/O) ports per node;
each port connected to the port of a node in a remote sub-network; and
the multiprocessing network having m(m+1)² nodes, and a diameter of 8 hops.

38. A highly multidimensional Flattened Butterfly having more than two dimensions;
the length of a linear set of connected nodes substantially the same in any one dimension;
each node connected to all other nodes in the linear set of each dimension; and
a substantially symmetric organization of the highly multidimensional Flattened Butterfly in all dimensions.

39. A highly multidimensional torus having more than three dimensions;
the length of a linear set of connected nodes substantially the same in any one dimension;
each node connected to two other nodes in the linear set of each dimension; and
a substantially symmetric organization of the highly multidimensional torus in all dimensions.
